(19) United States
(12) Patent Application Publication
(10) Pub. No.: US 2025/0233276 A1
(43) Pub. Date: Jul. 17, 2025

(54) RIGID PRINTED CIRCUIT BOARD BUS BAR CARRIER AND CELL INTERCONNECT

(71) Applicant: Caterpillar Inc., Peoria, IL (US)

(72) Inventors: Matthew Ryan SWANK, Washington, IL (US); Scott D. LARSON, Brimfield, IL (US); Jared J. BRODBECK, Metamora, IL (US); Trent MURRAY, Morton, IL (US)

(73) Assignee: Caterpillar Inc., Peoria, IL (US)

(21) Appl. No.: 18/411,547

(22) Filed: Jan. 12, 2024

(51) Int. Cl. H01M 50/507; H01M 10/42; H01M 50/519; H01M 50/583

(52) U.S. Cl. CPC H01M 50/507; H01M 10/425; H01M 50/519; H01M 50/583; H01M 2010/4271

(57) ABSTRACT

In some implementations, a battery module may include a battery stack comprising a plurality of battery cells, one or more module interconnect bus bars, and a printed circuit board (PCB) disposed on the battery stack and defining a plurality of openings. The PCB may be configured as a carrier for the one or more module interconnect bus bars. The plurality of openings may be arranged such that each of the plurality of openings aligns with a terminal of each of the plurality of battery cells. The one or more module interconnect bus bars may be attached to the PCB in alignment with the plurality of openings and electrically connected to the plurality of battery cells of the battery stack.

### TECHNICAL FIELD

The present disclosure relates generally to batteries and, for example, a rigid printed circuit board (PCB) bus bar carrier and cell interconnect.

### BACKGROUND

A machine may include one or more battery packs to provide power to components of the machine, such as lights, computer systems, and/or a motor, among other examples. A battery pack may be associated with a modular design that includes multiple battery modules. A battery module may include multiple battery cells. The battery cells may be connected in series or parallel via bus bars and cell interconnect circuits placed on an injection-molded, carrier. Manufacturing the battery module often requires placing the carrier on the battery cells separately from other components, which adds manufacturing complexity. Moreover, the carrier is an additional component that can increase the manufacturing cost of the battery module. Furthermore, the carrier is used as a fixture for assembling the battery cells, and increases a size of the battery module while serving little or no function after assembly.

China Patent No. 214176206 (the '206 patent) discloses a battery module connection acquisition structure that includes an integrated bus bar base film, a plurality of bus bar monomers and a plurality of acquisition circuit boards. The plurality of bus bar monomers and the plurality of acquisition circuit boards are arranged on the integrated bus bar base film. The integrated bus bar base membrane is provided with a plurality of hollow pole avoiding holes, and the hollow pole avoiding holes are used for allowing battery poles of the battery module to pass through and then to be connected with the bus bar monomers in a welding manner. Assembling the battery module of the '206 patent involves placing a buffer layer between a top of the battery cells and the bus bar base film. Electrodes and an acquisition circuit board are then placed on top of the bus bar base film. The '206 patent fails to disclose a carrier, however, which prevents the battery module acquisition structure from being separately assembled from the rest of the battery module. Further, without a carrier, the battery module acquisition structure of the '206 patent may require increased manufacturing complexity.

The rigid PCB carrier of the present disclosure solves one or more of the problems set forth above and/or other problems in the art.

### SUMMARY

A battery module may include a battery stack comprising a plurality of battery cells; one or more module interconnect bus bars; a printed circuit board (PCB) disposed on the battery stack and defining a plurality of openings, the PCB configured as a carrier for the one or more module interconnect bus bars, and the plurality of openings being arranged such that each of the plurality of openings aligns with a terminal of each of the plurality of battery cells, the one or more module interconnect bus bars being attached to the PCB in alignment with the plurality of openings and electrically connected to the plurality of battery cells of the battery stack.

A machine may include an electric motor; and a battery pack electrically connected to the electric motor, the battery pack including a plurality of battery cells and a PCB configured as a carrier for one or more bus bars, the PCB defining a plurality of openings being spaced from one another and collectively forming, in the PCB, a first row and a second row parallel to the first row, the plurality of openings being arranged such that each of the plurality of openings aligns with a terminal of each of the plurality of battery cells, and the one or more bus bars being attached to the PCB in alignment with the plurality of openings and electrically connected to the plurality of battery cells.

A carrier for a battery stack may include a printed circuit board defining a plurality of openings arranged to align with terminals of battery cells of the battery stack, the PCB configured to attach to one or more bus bars, and the plurality of openings configured to enable electrical connections between the battery cells and the one or more bus bars; and tabs electrically connecting the bus bars to the PCB.

### BRIEF DESCRIPTION OF THE DRAWINGS

FIG. 1 is a diagram of an example battery pack.

FIG. 2 is a perspective view of an example battery module.

FIG. 3 is a close-up view of a part of the example battery module of FIG. 2.

FIG. 4 is a side view of the example battery module of FIG. 2.

FIG. 5 is a top view of an example PCB and bus bars used with the battery module of FIG. 2.

FIG. 6 is a bottom view of the example PCB and bus bars of FIG. 5.

### DETAILED DESCRIPTION

This disclosure relates to a rigid PCB bus bar carrier and cell interconnect, which is applicable to any machine that uses power provided by a battery. For example, the machine may perform an operation associated with an industry, such as mining, construction, farming, transportation, or any other industry. For example, the machine may be a locomotive, an electric vehicle, an electric work machine (e.g., a compactor machine, a paving machine, a cold planer, a grading machine, a backhoe loader, a wheel loader, a harvester, an excavator, a motor grader, a skid steer loader, a tractor, and/or a dozer), or an energy storage system, among other examples. The concepts described herein are applicable to a battery cell, a battery module, and/or a battery pack. As used herein, “battery cell,” “battery,” and “cell” may be used interchangeably.

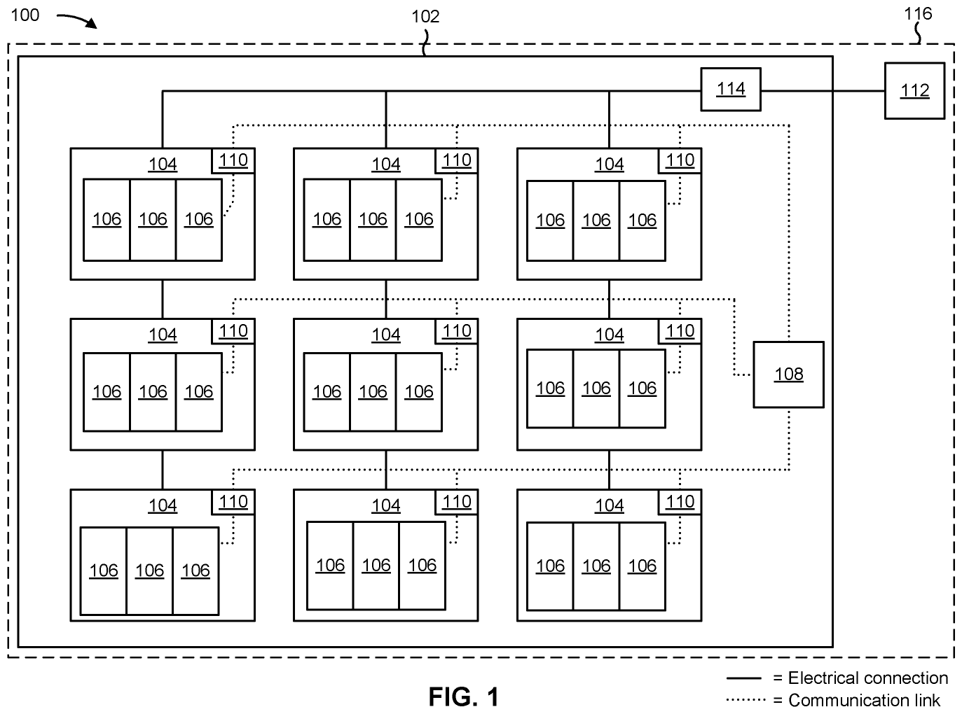

FIG. 1 is a diagram of an example battery pack 100. The battery pack 100 may include a battery pack housing 102, one or more battery modules 104, and one or more battery cells 106. The battery pack 100 includes a battery pack controller 108 associated with storing information and/or controlling one or more operations associated with the battery pack 100. Each battery module 104 includes a module controller 110 associated with storing information and/or controlling one or more operations associated with the battery module 104.

The battery pack 100 may be associated with a component 112. The component 112 may be powered by the battery pack 100. For example, the component 112 can be a load that consumes energy provided by the battery pack 100, such as an electric motor, among other examples. As another example, the component 112 provides energy to the battery pack 100 (e.g., to be stored by the battery cells 106). In such examples, the component 112 may be a power generator, a solar energy system, and/or a wind energy system, among other examples. A machine 116 may include the battery pack 100 and the component 112 (e.g., an electric motor). For example, the battery pack 100 (e.g., one or more battery modules 104 thereof) may be electrically connected to the component 112. The machine 114 may be an electric vehicle (e.g., a car, a train, or a boat) or an electric work machine.

The battery pack housing 102 may include metal shielding (e.g., steel, aluminum, or the like) to protect elements (e.g., battery modules 104, battery cells 106, the battery pack controller 108, the module controllers 110, wires, circuit boards, or the like) positioned within battery pack housing 102. Each battery module 104 includes one or more (e.g., a plurality of) battery cells 106 (e.g., positioned within a housing of the battery module 104). Battery cells 106 may be connected in series and/or in parallel within the battery module 104 (e.g., via terminal-to-bus bar welds). Each battery cell 106 is associated with a chemistry type. The chemistry type may include lithium ion (Li-ion), nickel-metal hydride (NiMH), nickel cadmium (NiCd), lithium ion polymer (Li-ion polymer), lithium iron phosphate (LFP), and/or nickel manganese cobalt (NMC), among other examples.

The battery modules 104 may be arranged within the battery pack 100 in one or more strings. For example, the battery modules 104 are connected via electrical connections, as shown in FIG. 1. The electrical connections may be removable, such as via bolts and/or nuts at one or more terminals on housings of the battery modules 104. The battery modules 104 may be connected in series and/or in parallel. For example, a number of battery modules 104 may be connected in series to provide a particular voltage (e.g., to the component 112). Alternatively, a number of battery modules 104 may be connected in parallel to increase a current and/or a power output of the battery pack 100. The number of battery cells 106 included in each battery module 104, and the number of battery modules 104 included in the battery pack 100 (e.g., and the relative serial and/or parallel connections of the battery cells 106 and/or the battery modules 104) may be associated with the required output power and an intended use of the battery pack 100. For example, any number of battery cells 106 can be included in a battery module 104. Similarly, any number of battery modules 104 can be included in the battery pack 100.

The battery pack controller 108 is communicatively connected (e.g., via a communication link) to each module controller 110. The battery pack controller 108 may be associated with receiving, generating, storing, processing, providing, and/or routing information associated with the battery pack 100. The battery pack controller 108 may also be referred to as a battery pack management device or system. The battery pack controller 108 may communicate with the component 112 and/or a controller of the component 112, may control a start-up and/or shut-down procedure of the battery pack 100, may monitor a current and/or voltage of a string (e.g., of battery modules 104), and/or may monitor and/or control a current and/or voltage provided by the battery pack 100, among other examples. A module controller 110 may be associated with receiving, generating, storing, processing, providing, and/or routing information associated with a battery module 104. The module controller 110 may communicate with the battery pack controller 108.

The battery pack controller 108 and/or a module controller 110 may be associated with monitoring and/or determining a state of charge (SOC), a state of health (SOH), a depth of discharge (DOD), an output voltage, a temperature, and/or an internal resistance and impedance, among other examples, associated with a battery module 104 and/or associated with the battery pack 100. Additionally, or alternatively, the battery pack controller 108 and/or the module controller 110 may be associated with monitoring, controlling, and/or reporting one or more parameters associated with battery cells 106. The one or more parameters may include cell voltages, temperatures, chemistry types, a cell energy throughput, a cell internal resistance, and/or a quantity of charge-discharge cycles of a battery module 104, among other examples.

The battery pack 100 may further include one or more circuits 114 for protecting against spikes in current, voltage, or both. For example, as discussed in greater detail below, the circuits 114 may include one or more trace fuses or surface mounted fuses and/or may provide transient voltage suppression.

As indicated above, FIG. 1 is provided as an example. Other examples may differ from what is described with regard to FIG. 1.

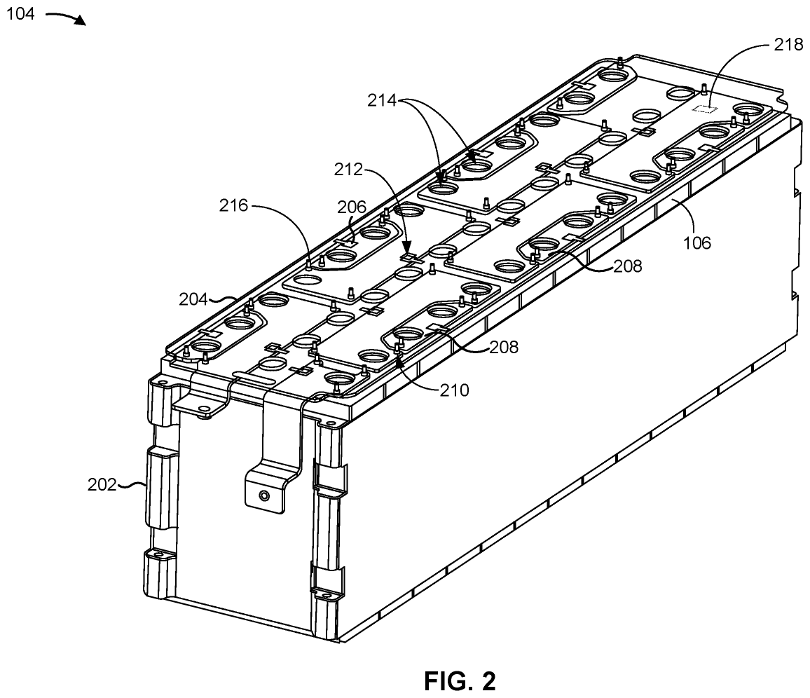

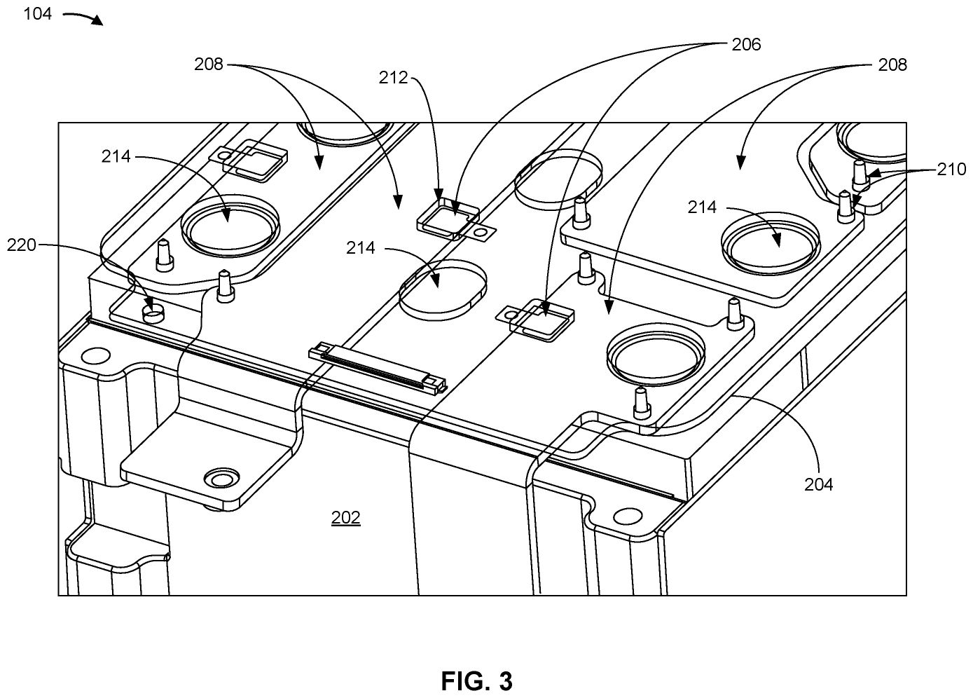

FIGS. 2 and 3 show an example battery module 104. In particular, FIG. 2 is a perspective view of the battery module 104, and FIG. 3 is a close-up view of a part of the battery module 104. The battery module 104 includes a module housing 202, a PCB 204 (shown as translucent in the figures for purposes of clarity), tabs 206, and bus bars 208 (also called “module interconnect bus bars”).

The module housing 202 may house one or more of the battery cells 106 arranged in a battery stack, discussed above with respect to FIG. 1. The module housing 202 may be formed from plastic, metal, or another rigid material. The module housing 202 may be used to generally protect the battery cells 106 from external forces and potential contaminants. In some scenarios, the module housing 202 may further help maintain the temperature of the battery cells 106 through, for example, heat dissipation.

The PCB 204 may be a thin, unitary, rigid plate made from a composite material and configured as a holder for the bus bars 208. For example, the PCB 204 may have the dual purposes of providing electrical connectivity for the battery stack and aligning the bus bars 208 with the battery cells 106. The PCB 204 may be formed from a rigid material. For example, the plate of the PCB 204 may be made from, for example, a material such as flame retardant 4 (FR4) (e.g., the PCB 204 may be formed from FR4), which may include a woven fiberglass cloth and an epoxy resin binder. The PCB 204 may be an electrical insulator and include traces printed onto the plate. The traces may be used to connect various electrical components of the battery module 104. The PCB 204 may be formed of a single layer or multiple layers (e.g., a multiple-layer PCB) to, for example, provide consistent trace resistance (e.g., trace resistance balancing) across different traces. The PCB 204 may be at least partially disposed on a top surface of the module housing 202 and/or on the tops of the battery cells 106. The PCB 204 may be disposed over one or more electrically conductive regions of each of the plurality of battery cells 106, thereby reducing a risk of accidental contact to the electrically conductive regions. For example, the PCB 204 may extend over the terminals of each of the plurality of battery cells 106. As discussed in greater detail below, the PCB 204 may include aligning holes 210, access holes 212, and openings 214.

The tabs 206 may be formed from nickel or another metal. The tabs 206 may directly electrically connect the bus bars 208 to the PCB 204 to, for example, facilitate voltage measurements of one or more battery cells 106 covered by the PCB 204. The tabs 206 may contact the bus bars 208 and may be accessible via traces in the PCB 204 and/or through the access holes 212 of the PCB 204. In some implementations, wire bonds may be used instead of or in addition to the tabs 206.

The bus bars 208 may be formed of strips or bars of a conductive material. The bus bars 208 may serve as a conduit for allowing electrical currents to flow between individual battery cells 106, groups of battery cells 106, and/or between battery modules 104. For example, two or more of the bus bars 208 may serve as terminals of the battery module 104, such as a positive terminal and a negative terminal. The bus bars 208 may have similar shapes, thicknesses, cross-sectional areas, or other characteristic relative to one another to help maintain a consistent electrical connection between battery cells 106 in the battery module 104. The bus bars 208 may be disposed between the PCB 204 and a top surface of the battery cell terminals such that the PCB 204 provides an insulating layer between the bus bars 208 and the battery module 104 housing 202. The bus bars 208 may be attached to the PCB 204 via fasteners 216, such as rivets, or via an adhesive. For example, the PCB 204 may be a carrier for the bus bars 208 that enables pre-alignment of the bus bars 208 with the battery cells 106. When fasteners 216 are used to connect the bus bars 208 to the PCB 204, both the bus bars 208 and the PCB 204 may include aligning holes 210 defined therein, and the fasteners 216 may extend through the aligning holes 210. Accordingly, the aligning holes 210 may help align the bus bars 208 with the PCB 204, the battery cells 106, or both. Because the bus bars 208 may be disposed between the PCB 204 and the module housing 202, and because the PCB 204 may be formed from a non-conductive material, the PCB 204 may insulate the bus bars 208 from other electrical components in the battery module 104.

One or more of the openings 214 may be aligned with one or more bus bars 208 and one or more of the battery cells 106, which may allow each of the bus bars 208 to be attached (e.g., bolted or welded) to the battery cells 106. Examples of welding techniques to attach the bus bars 208 to the battery cells 106 may include laser welding, sonic welding, metal inert gas (MIG) welding, tungsten inert gas (TIG) welding, and/or a combination thereof, among other examples. Additional openings, such as openings 220 (see FIG. 3) that allow alignment of the PCB 204 to the module housing 202 of the battery module 104. Alternatively or in addition, the openings along the center of the PCB 204 may facilitate cell ventilation by allowing gas to vent.

Additional components, such as one or more trace fuses or surface mounted fuses 218, may be disposed on or incorporated into the PCB 204. For instance, a trace fuse may be incorporated into one or more traces of the PCB 204. The trace fuse may be a section of the trace designed to fail when provided with an electrical current above a certain value. For example, the trace fuse may have a width, thickness, or cross-sectional area unable to support electrical currents above the certain value, which will cause the trace fuse to fail, thereby breaking the electrical connection and offering some level of protection to other electronic components. Additionally, or alternatively, one or more surface mounted fuses 218 may be disposed on the PCB 204, and each of the surface mounted fuses 218 may be electrically connected to at least one of the bus bars 208. For example, a surface mounted fuse 218 may be a discrete component electrically connected to a bus bar 208 and to one or more traces of the PCB 204. The surface mounted fuse 218 may be configured to intentionally fail when an electrical current of the bus bar 208 exceeds a predetermined value. For example, the surface mounted fuse 218 may melt, thereby breaking the electrical connection, when subjected to electrical currents above the certain value. The surface mounted fuses 218, being accessible from the surface of the PCB 204, may be easier to service and replace relative to trace fuses.

The PCB 204 may include components related to transient voltage suppression (e.g., transient voltage suppressors) to, for example, divert or clamp transient voltages before transient voltages can damage other electronic components of the battery module 104. Examples of components related to transient voltage suppression may include one or more of diodes, varistors, temperature sensors (e.g., thermistors), liquid sensors, gas detection sensors, and/or a combination thereof, among other examples. Other electronic components that may be integrated into the PCB may include one or more connectors. The PCB 204 may, in some instances, include one or more components of a battery management system (e.g., battery pack controller 108 and/or module controller 110 discussed above with respect to FIG. 1). Further, the PCB may electrically connect one or more components of the battery management system to one or more of the battery cells.

As indicated above, FIGS. 2 and 3 are provided as an example. Other examples may differ from what is described with regard to FIGS. 2-3.

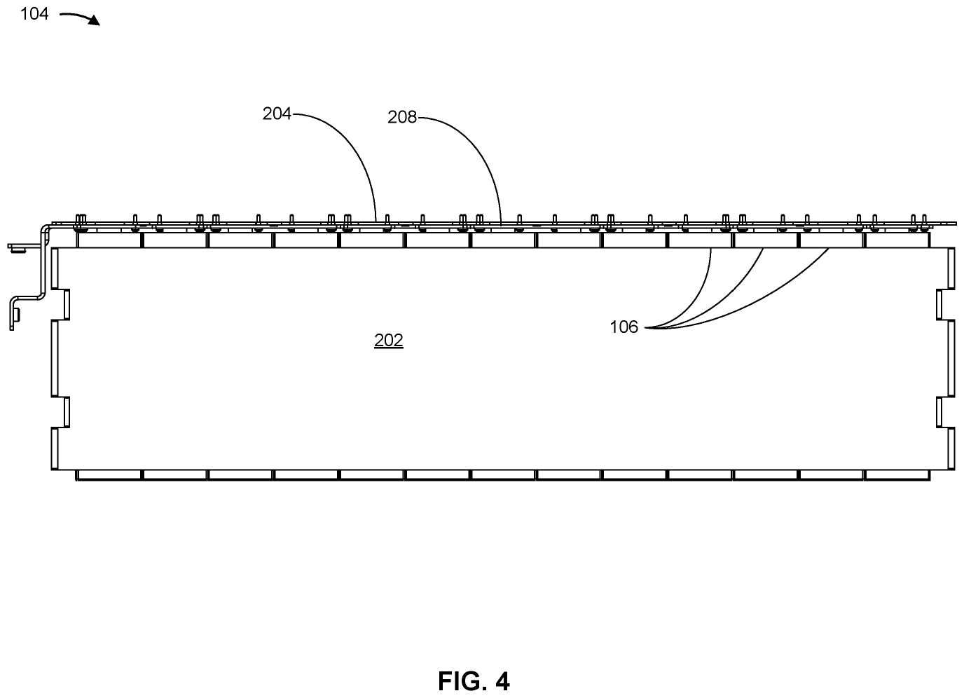

FIG. 4 is a side view of the example battery module 104, shown and discussed above with respect to FIGS. 2 and 3. The battery module 104 may include a battery stack that includes multiple battery cells 106 inside the module housing 202. Further, as shown in FIG. 4, the PCB 204 may be disposed over the electrically conductive regions of each of the battery cells 106 and/or over the bus bars 208, thereby serving as an electrical insulator.

As indicated above, FIG. 4 is provided as an example. Other examples may differ from what is described with regard to FIG. 4.

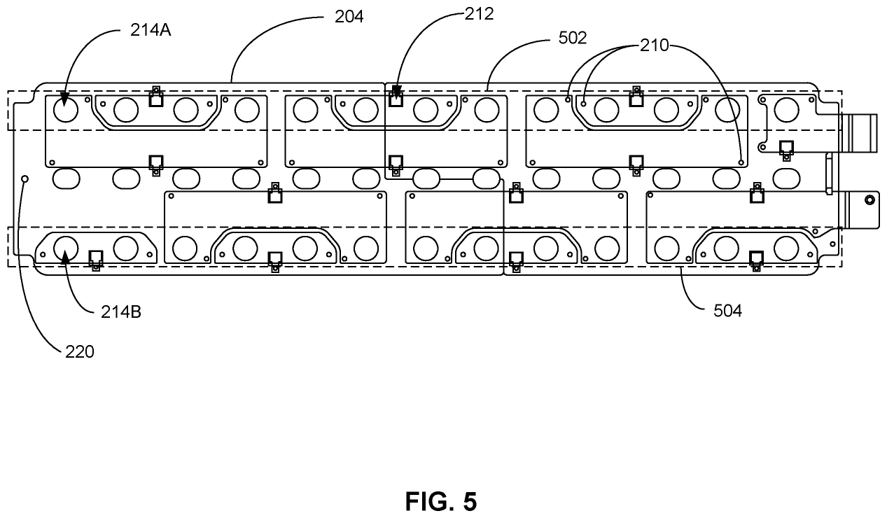

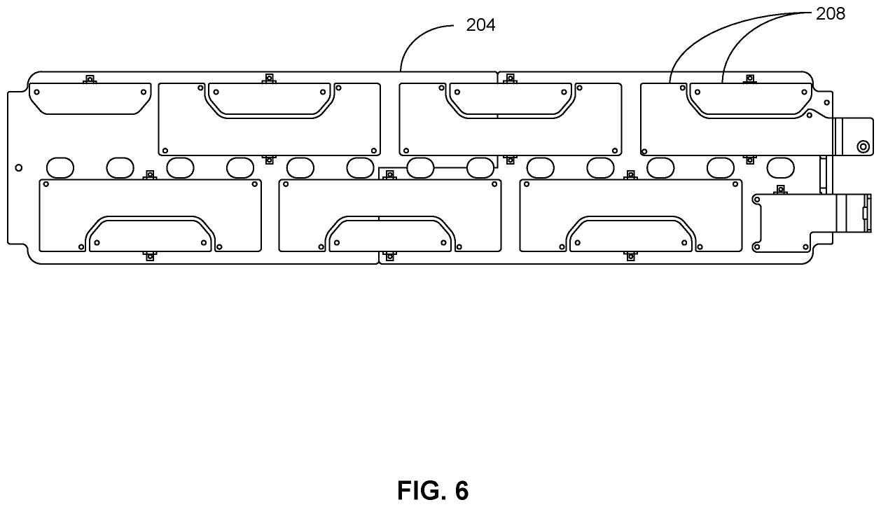

FIGS. 5 and 6 show a top view and bottom view, respectively, of an example PCB 204 and bus bars 208. As shown in FIG. 5, the PCB 204 includes the aligning holes 210 and 220, the access holes 212, and the openings 214 (shown as 214A and 214B), discussed above with respect to FIGS. 2 and 3. As shown in FIG. 6, the bus bars 208 may be attached to the bottom surface of the PCB 204 through fasteners 216 (via, for example, the aligning holes 210) and/or an adhesive such that each bus bar 208 is aligned with at least one of the openings 214. For example, the bus bar 208 may be aligned with at least one of the openings 214 if the bus bar 208, attached to the bottom surface of the PCB 204, is accessible from the top surface of the PCB via, for example, the opening 214. The alignment of the bus bars 208 with the openings 214 allows the bus bars 208 to be welded to the battery cells 106 via the openings 214 (e.g., the openings 214 may be configured to enable electrical connections between the battery cells 106 and the bus bars 208). The openings 214 may be spaced from one another and collectively form, in the PCB 204, at least a first row 502 and a second row 504. The first row 502 and the second row 504 may be parallel to one another. The openings 214 may be arranged in pairs where each opening 214 in the pair comes from a different row. For example, a first opening 214A in the pair of openings 214 may be in the first row 502 and a second opening 214B in the pair of openings 214 may be in the second row 504. Each pair of openings 214 may correspond to one of the battery cells 106. For example, the first opening 214A and the second opening 214B may align with different terminals of the same battery cell 106. Accordingly, one or more bus bars 208 can be aligned with and welded to the terminals of the battery cell 106 via the pair of openings 214.

As indicated above, FIGS. 5 and 6 are provided as examples. Other examples may differ from what is described with regard to FIGS. 5 and 6.

### INDUSTRIAL APPLICABILITY

The rigid PCB carrier described herein may used to connect battery cells together to form a battery module as well as facilitate the connection of multiple battery modules in a battery pack. The battery pack with the rigid PCB carrier may be used in any machine that uses power provided by a battery. For example, the battery pack may be installed in a locomotive, an electric vehicle, an electric work machine (e.g., a compactor machine, a paving machine, a cold planer, a grading machine, a backhoe loader, a wheel loader, a harvester, an excavator, a motor grader, a skid steer loader, a tractor, and/or a dozer), or an energy storage system, among other examples.

By having the PCB serve as a bus bar carrier and cell interconnect, as discussed above, the PCB, bus bar, tabs, and possibly other components can be pre-assembled prior to being attached to the module housing, which may reduce manufacturing time and complexity. Further, using the rigid PCB carrier as disclosed herein combines the functionality of circuitry and a carrier, which otherwise may be provided as separate components, into a single component, thereby simplifying the battery module, reducing a size of the battery module, simplifying manufacturing of the battery module, and reducing a cost of the battery module. For example, the rigid PCB described herein may eliminate the need for additional harnesses or a flexible structure. Furthermore, the rigid PCB carrier may provide additional insulation between the bus bar and other components of the battery module and/or battery pack, thereby improving an electrical performance and resilience of the battery module and/or battery pack.

What is claimed is:

1. A battery module, comprising:
a battery stack comprising a plurality of battery cells;
one or more module interconnect bus bars; and
a printed circuit board (PCB) disposed on the battery stack and defining a plurality of openings,
the PCB configured as a carrier for the one or more module interconnect bus bars, and
the plurality of openings being arranged such that each of the plurality of openings aligns with a terminal of each of the plurality of battery cells,
the one or more module interconnect bus bars being attached to the PCB in alignment with the plurality of openings and electrically connected to the plurality of battery cells of the battery stack.

2. The battery module of claim 1, wherein the one or more module interconnect bus bars are attached to the plurality of battery cells via the plurality of openings.

3. The battery module of claim 1, wherein the one or more module interconnect bus bars are attached to the PCB via a fastener or an adhesive.

4. The battery module of claim 3, wherein the fastener extends through aligning holes defined in the one or more module interconnect bus bars and the PCB.

5. The battery module of claim 1, wherein the one or more module interconnect bus bars are electrically connected to the PCB via one or more tabs or wire bonds.

6. The battery module of claim 1, wherein the PCB is formed from a rigid material.

7. The battery module of claim 1, wherein the PCB is a unitary plate.

8. The battery module of claim 1, wherein the plurality of openings are spaced from one another and collectively form, in the PCB, at least a first row and a second row parallel to the first row.

9. The battery module of claim 8, wherein two of the plurality of openings are arranged in pairs, the pairs including one of the plurality of openings in the first row and another of the plurality of openings in the second row, and each pair corresponding to one of the plurality of battery cells in the battery stack.

10. The battery module of claim 1, wherein the PCB is disposed over one or more electrically conductive regions of each of the plurality of battery cells, the one or more electrically conductive regions including two terminals of each of the plurality of battery cells.

11. The battery module of claim 1, further comprising one or more surface mounted fuses or trace fuses disposed on the PCB, each of the one or more surface mounted fuses or trace fuses being electrically connected to at least one of the one or more module interconnect bus bars.

12. The battery module of claim 1, wherein the PCB is a multiple-layer or single layer PCB.

13. The battery module of claim 1, further comprising one or more of transient voltage suppressors, connectors, or thermistors integrated into the PCB.

14. The battery module of claim 1, further comprising a battery management system disposed on the PCB, wherein the PCB electrically connects the battery management system to one or more of the plurality of battery cells.

15. A machine, comprising:
an electric motor; and
a battery pack electrically connected to the electric motor, the battery pack including a plurality of battery cells and a printed circuit board (PCB) configured as a carrier for one or more bus bars,
the PCB defining a plurality of openings being spaced from one another and collectively forming, in the PCB, a first row and a second row parallel to the first row,
the plurality of openings being arranged such that each of the plurality of openings aligns with a terminal of each of the plurality of battery cells, and
the one or more bus bars being attached to the PCB in alignment with the plurality of openings and electrically connected to the plurality of battery cells.

16. The machine of claim 15, wherein the one or more bus bars are electrically connected to the PCB via one or more tabs or wire bonds.

17. The machine of claim 15, wherein the plurality of openings are arranged in pairs, the pairs including one of the plurality of openings in the first row and another of the plurality of openings in the second row, and each pair corresponding to one of the plurality of battery cells.

18. The machine of claim 15, wherein the PCB electrically connects one or more battery cells and a module controller.

19. A carrier for a battery stack, comprising:
a printed circuit board (PCB) defining a plurality of openings arranged to align with terminals of a plurality of battery cells of the battery stack; and
one or more bus bars attached to the PCB in alignment with the plurality of openings, the plurality of openings configured to enable electrical connections between the plurality of battery cells and the one or more bus bars.

20. The carrier of claim 19, wherein:
the plurality of openings are spaced from one another and collectively form, in the PCB, at least a first row and a second row parallel to the first row; and
the plurality of openings are arranged in pairs, the pairs including one of the plurality of openings in the first row and another of the plurality of openings in the second row, and each pair configured to align one of the plurality of battery cells.
